(19) United States
(12) Patent Application Publication
(10) Pub. No.: US 2012/0095627 A1
(43) Pub. Date: Apr. 19, 2012

(54) METHOD OF ALERTING HORN RULE TIMING

(75) Inventors: Richard J. MATUSIAK, Watertown, NY (US); C. Mackay FOSTER, Burleson, TX (US)

(73) Assignee: New York Air Brake Corporation, Watertown, NY (US)

(21) Appl. No.: 12/907,289

(22) Filed: Oct. 19, 2010

(51) Int. Cl. G05D 1/00; B60Q 1/00

(52) U.S. Cl. 701/19; 340/438

(57) ABSTRACT

The present method includes determining the locomotive's present location on the track; and determining the present speed of the locomotive. From the present location of the locomotive and the present speed of the locomotive, a horn rule locations on the track for a point of interest is determined; and the operator is alerted to the horn rule location on the track. The horn rule location may include horn start and stop locations and horn free zones.

### BACKGROUND AND SUMMARY OF THE DISCLOSURE

Since the inception of the railroad, the horn (whistle) has been an important device which is intended to warn people and animals near railroad tracks of an oncoming train. Key areas or points of interest where the railroads have focused on the use of the horn through the years are railroad crossings. Many years ago railroads began placing “whistle” boards near the track in advance of road crossings to remind the engineers to sound their horn. The locations of these boards were based on the particular maximum speed the train was allowed to travel on the track at the time they were placed. The distance was calculated to ensure a particular horn cadence could be sounded far enough in advance of and through the crossing. Over time crossing have been moved, tracks changed, and maximum speeds modified.

Over the past two decades, the Untied States Federal Railway Administration FRA, has started to mandate and enforce very strict rules regarding the use of the horn. This includes both when it should be sounded as well as when it should not. These restrictions have placed very tight restrictions on the engineers to properly sound the horn. The most difficult problem with this is that the rules are based on time and not distance. This means that the location at which the engineer is required to begin to sound the horn is variable as it ultimately varies based on the speed of the train. Since the speed of the train is dependent on many factors including civil speed limits, daily speed restrictions, weight of the train, horsepower, track geometry, and others, the location at which the engineers are required start sounding the horn and stop sounding the horn are becoming more and more critical. To aid in the determination of this the railroad has in many cases given their engineers tables which they can carry that give them a distance when they need to begin sounding the horn prior to the crossing based on their speed. The problem with this is that the engineers still aren't exactly aware what the distance to the crossing is.

The present method uses, for example the LEADER's® system look ahead and display capabilities to determine and alert by display or indicators which inform the engineer or operator of the earliest location on the track at which the horn can be sounded. Additionally, indicators could be displayed which will allow the engineer to know the locations up to which the horn must be sounded and can no longer be sounded or not sounded at all.

The present method includes determining the locomotive's present location on the track; and determining the present speed of the locomotive. From the present location of the locomotive and the present speed of the locomotive, a horn rule location on the track for a point of interest is determined; and the operator is alerted to horn start location on the track.

A speed profile from the present position to the point of interest may be determined and used to determine the horn start location on the track. The horn rule locations may include a horn may start location, a horn must start location and a horn stop location on the track for the point of interest and may be determined and displayed. The length of time required for a selected horn cadence may be determined and used to determine the horn start location on the track. The specific horn rule parameters of timing for various horn locations may be communicated to the locomotive via a method which allows modification and specification of the parameters prior to departure or in route automatically or by the engineer via an input device.

The method is performed by software on a processor or computer on the locomotive.

These and other objects, features, and advantages of the present disclosure may be better understood and appreciated from the following detailed description of the embodiments thereof, selected for purposes of illustration and shown in the accompanying drawings.

### BRIEF DESCRIPTION OF THE DRAWINGS

FIG. 1 is a display incorporating the horn rule timing according to the principles of the present disclosure.

FIG. 2 is a flow chart for determining the horn rule timing according to the present disclosure.

### DETAILED DESCRIPTION OF THE PREFERRED EMBODIMENTS

For the present method, the LEADER® system by New York Air Brake will be used as an example of a processor or computer on which the method can be performed. Other processors or computers on the locomotive may be used. The LEADER® system simulates the entire train movement in real time and with its look-ahead technology, can predict the train dynamics on a forward looking basis. This capability is used to provide the engineer with “driver assist prompts” in order to optimize the train handling with respect to in train forces, fuel economy, standard operating practices and time to destination. These parameters are weighted according to the requirements of the client railroad. An explanation of the LEADER® system is found in U.S. Pat. No. 6,587,764, which is incorporated herein by reference.

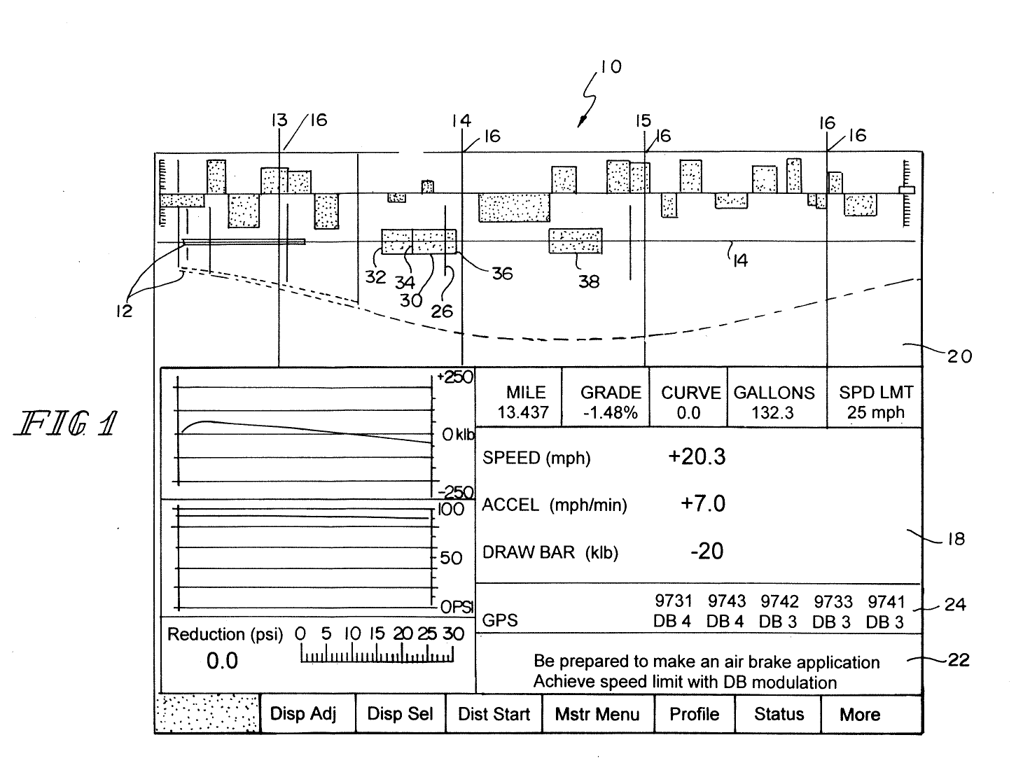

FIG. 1 illustrates a display 10 within the cabin of the locomotive. Reference to FIG. 5 of U.S. Pat. No. 6,144,901 provides details of the various elements of the display. Only those of interest to the present disclosure will be described in detail. A train 12 is shown on a track 14. There is a vertical and a horizontal display of the train on the track. Sign posts 16 are illustrated crossing the various track locations. The box 18 displays the present speed, the acceleration and draw bar forces.

Other messages that may be provided to the operator includes message box 22 which provides, for example, a message “be prepared to make an air brake application” and “achieves speed limit through the DB modulation.” DB is dynamic brake. Box 24 may show a suggested dynamic brake application at a specific GPS location or the current propulsion system setting for each locomotive and the status of the GPS system, for example. The DB numbers are representative of a notch of the propulsion handle in the dynamic brake region.

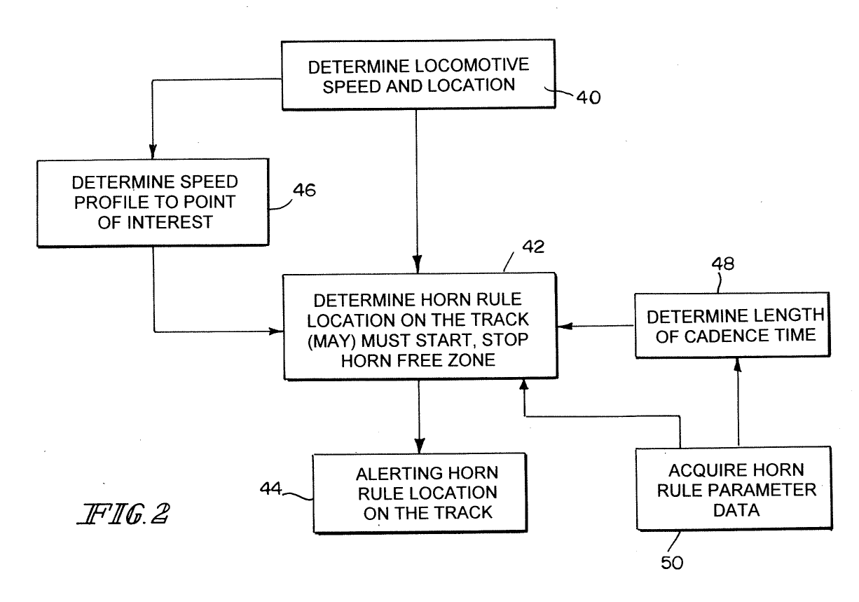

As will be described with respect to FIG. 2, the present system determines the present location of the locomotive on the track and locomotive speed. From the present location of the locomotive, the present speed of the locomotive, and the parameters related to the horn rule (time/distance to start in advance and applicability to the point of interest), a horn start location on the track when the horn is to begin blowing for a point of interest is determined. The horn start location on the track is displayed. Also, a may start blowing, a must start blowing, a stop blow locations and horn free zones may be determined and displayed A speed profile from the present position to the point of interest may be determined and used to determine the horn start location on the track. The length of time required for a selected horn cadence may be determined and used to determine the horn start location on the track.

The horn rule timing is illustrated in FIG. 1 by the boxes 20. The point of interest 26 may be for example a rail crossing. The indicia 30 is a zone of horn activation and includes a horn may start location 32, a horn must start location 34 and a horn stop location 36 on the track for the point of interest. Also shown is a horn free zone 38. The operator may also be alerted to the horn rule location by displaying the horn rule as a message as the locomotive is at the horn rule location and/or activating an audio or visual indicator as the locomotive is at the horn rule location.

A flow chart of the present method is illustrated in FIG. 2. At step 40, there is a determination of train speed and track location. At step 42, there is a determination or calculation of a horn rule location along the track based on the present speed and location. The horn rule location at a minimum would be a horn must start location 34 and may include a horn may start location 32, based on local ordinances and track restrictions supplied by step 50. Also, a horn stop location 36 and horn free zones 38 may be determined based on data supplied from step 50. At step 44, the operator is alerted to the horn locations by display or indicators for example.

The horn rule parameter data acquired at step 50 includes, for example, a start parameter, a total duration parameter, a stop parameter, a cadence parameter, a location applicability parameter, etc. This data may be communicated to the locomotive via a method which allows modification and specification of the parameters prior to departure or in route automatically or by the engineer via an input device. The parameter data may be general for all points of interest or may be specific for each or some points of interest.

The location at which the engineer is required to begin to sound the horn is variable as it is dependent on the speed of the train. Since the speed of the train is dependent on many factors including civil speed limits, daily speed restrictions, weight of the train, horsepower, track geometry, and others, a more accurate determination of the horn rule locations on the track may be determined at step 46. A speed profile is determined from the present location to the point of interest 26. The speed profile is determined from the present speed and location from step 40 and one or more of time to point of interest, speed limits between the present position and the point of interest, track topology between the present position and the point of interest, weight of the train, horse power, fuel usage, throttle control settings, brake control settings, and train forces. These are part of the calculations that can be performed on the LEADER® system. This more accurate information from step 46 is used in step 42 to determine more precise horn rule locations.

The horn rule locations may also vary base on the horn cadence. This would include the length of time of the cadence and how long the cadence should continue through and after the point of interest. Step 48 determines the length of time of the cadence as supplied by step 50 and provides this information to step 42 for the determination of the horn rule locations.

Accordingly, it will be understood that the preferred embodiment of the present invention has been disclosed by way of example and that other modifications and alterations may occur to those skilled in the art. Although the use of the LEADER system and displays has been discussed, the disclosed processes and displays may be used on any locomotive display.

What is claimed:

1. A method of alerting an operator of a horn rule timing on a locomotive along a track, the method comprising:
determining the present location of the locomotive on the track;
determining the present speed of the locomotive;
determining, from the present location of the locomotive and the present speed of the locomotive, a horn rule location on the track for a point of interest; and
alerting the operator of the horn rule location on the track.

2. The method of claim 1, including determining a speed profile from the present position to the point of interest; and determining the horn rule location on the track from the present location of the locomotive, the present speed of the locomotive and the speed profile.

3. The method of claim 2, wherein the speed profile is determined from one or more of time to point of interest, speed limits between the present position and the point of interest, track topology between the present position and the point of interest, weight of the train, horse power, fuel usage, throttle control settings, brake control settings, and train forces.

4. The method of claim 1, wherein the horn rule locations include a horn start location when the horn is to start blowing and a horn stop location on the track when the horn is to stop blowing for the point of interest based on horn rule parameters.

5. The method of claim 1, wherein the horn rule locations include a horn may start location and a horn must start location on the track for the point of interest based on horn rule parameters.

6. The method of claim 1, wherein the horn rule locations include a horn free zone on the track where the horn is not to be blown.

7. The method of claim 1, including determining the length of time required for a selected horn cadence; and determining, from the present location of the locomotive, the present speed of the locomotive and the length of cadence time, the horn rule location on the track.

8. The method of claim 1, wherein alerting the operator includes at least one of displaying the location of the horn rule location on a display of the track; displaying the horn rule as a message as the locomotive is at the horn rule location, and activating an audio or visual indicator as the locomotive is at the horn rule location.

9. A locomotive controller comprising:
an input device, a display and a processor for driving the display and receiving inputs from the input device; and
software in the processor for determining and alerting a operator on the locomotive, from the present location of the locomotive and the present speed of the locomotive, a horn rule location on the track when the horn is to begin blowing for a point of interest.

10. The controller according to claim 9, wherein the software determines a speed profile from the present position to the point of interest; and determines the horn rule location on the track from the present location of the locomotive, the present speed of the locomotive and the speed profile.

11. The controller of claim 9, wherein the horn rule locations include a horn start location when the horn is to start blowing and a horn stop location on the track when the horn is to stop blowing for the point of interest based on inputted horn rule parameters.

12. The controller of claim 9, wherein the horn rule locations include a horn may start location and a horn must stop on the track for the point of interest based on inputted horn rule parameters.

13. The controller of claim 9, wherein the horn rule locations include a horn free zone on the track where the horn is not to be blown; and drives the display to display the horn free zone on the track display.

14. The controller of claim 9, wherein the software determines the length of time required for a selected horn cadence; and determines, from the present location of the locomotive, the present speed of the locomotive and the length of cadence time, the horn start location on the track.

15. The controller of claim 9, wherein alerting the operator includes at least one of displaying the location of the horn rule location on the display of the track; displaying the horn rule as a message as the locomotive is at the horn rule location on the display, and activating an audio or visual indicator as the locomotive is at the horn rule location.
